(19) United States
(12) Patent Application Publication
(10) Pub. No.: US 2024/0157721 A1
(43) Pub. Date: May 16, 2024

(54) AN EFFORT-SAVING BINDER CLIP

(71) Applicant: AIVEN ON STATIONERY CO., LTD., Ningbo City, Zhe jiang (CN)

(72) Inventor: Jin Huang, Ninghai County, Zhejiang Province (CN)

(73) Assignee: AIVEN ON STATIONERY CO., LTD., Ningbo City, Zhe jiang (CN)

(21) Appl. No.: 17/779,674

(22) PCT Filed: Dec. 31, 2021
(86) PCT No.: PCT/CN2021/143610

§ 371 Date: May 25, 2022

(30) Foreign Application Priority Data
Jan. 25, 2021 (CN) 202110095249.5

(51) Int. Cl. B42F 1/00

(52) U.S. Cl. CPC B42F 1/006

(57) ABSTRACT

This invention relates to an effort-saving binder clip, comprising clamping parts, a rear part, and rod members. When the binder clip is used, the first rod member passes through the first hole, and contacts one end of the first clamping part against the opening side of Part A, forming a first fulcrum. From the first fulcrum to the pivotal part, a gap exists between the first rod member and the first clamping part; the second rod member passes through the second hole, and contacts one end of the second clamping part against the opening side of Part C, forming a second fulcrum. From the second fulcrum to the pivotal part, a gap exists between the second rod member and the second clamping part; additional protruding fulcrums are not necessarily arranged on the clamping parts or rod members so as to save effort and greatly simplify production.

### REFERENCE TO PRIOR APPLICATION

This application claims priority to Chinese Patent Application 202110095249.5, filed on Jan. 25, 2021, which is incorporated herein by reference.

### FIELD OF THE INVENTION

This invention relates to the technical field of binder clips, in particular to an effort-saving binder clip.

### BACKGROUND OF THE INVENTION

Binder clips are widely used in daily office work or life. Generally, a binder clip comprises clamping parts, a rear part, and rod members. Two clamping parts are arranged the rear part is arranged at one end of the clamping parts and connects the two clamping parts which form an openable opening at the other end. A pivotal part is arranged at the other end of each clamping part. Two rod members are arranged and correspond to the clamping parts. For the convenience of description, the two clamping parts are marked as the first clamping part, the second clamping part; and the two rod members are marked as the first rod member, the second rod member, respectively. When the binder clip is used, one end of the first rod member and one end of the second rod member both exceed in length the rear part for the convenience of users to press the exceeding parts against each other. The other end of the first rod member is pivotally connected with the pivotal part of the first clamping part, and the other end of the second rod member is pivotally connected with the pivotal part of the second clamping part. Binder clips are roughly designed as described above, which feature simple structure, less components, and little room for adjustment, so it is difficult to adjust or further improve their structure.

In the prior art, fulcrums are usually arranged between clamping parts and rod members to save effort. After fulcrums are arranged, power arms are longer while resisting arms are shorter, but some other protruding fulcrums need to be arranged on clamping parts or rod members, which increases the complexity of production and processing. Such structure has been disclosed in Japanese invention patent JP3117841U which was published early, and in US invention patent U.S. Pat. No. 5,806,147A which was published even earlier (Sep. 15, 1998). However, up to now, this structure has been adopted in the industry without any fundamental breakthrough, such as recently published Chinese invention patents CN109228731A, CN208263788U, etc. This shows that a fixed mindset has been held in the industry relating to effort-saving design without any further breakthrough.

### SUMMARY OF THE INVENTION

### (i) Technical Problem

The present invention proposes an effort-saving binder clip to overcome the shortcomings and deficiencies of the prior art mentioned above, which can achieve the purpose of saving effort without arranging additional protruding fulcrums on clamping parts or rod members, and can greatly simplify production and processing.

### (ii) Technical Scheme

In order to solve the above-mentioned technical problems, the present invention proposes an effort-saving binder clip. The technical scheme is detailed as follows:

The present invention provides an effort-saving binder clip, comprising clamping parts, a rear part, and rod members. Two clamping parts are arranged, the rear part is arranged at one end of the clamping parts and connects the two clamping parts which form an openable opening at the other end. A pivotal part is arranged at the other end of each clamping part. Two rod members are arranged and correspond to the clamping parts. The two clamping parts are marked as the first clamping part, the second clamping part, and the two rod members are marked as the first rod member, the second rod member, respectively. When the binder clip is used, one end of the first rod member and one end of the second rod member both exceed in length the rear part for the convenience of users to press the exceeding parts against each other. The other end of the first rod member is pivotally connected with the pivotal part of the first clamping part, and the other end of the second rod member is pivotally connected with the pivotal part of the second clamping part. Holes are both arranged between the first clamping part and the rear part and between the second clamping part and the rear part. The hole between the first clamping part and the rear part is marked as the first hole, and the hole between the second clamping part and the rear part is marked as the second hole. Part A of the first hole is arranged in the first clamping part, and Part B is arranged in the rear part. In addition, Part A extends toward the opening side. The length of Part A from the rear part to the opening side is given in a closed interval [1/10H, 1/2H], where H is the length of the first clamping part from the rear part to the opening side; Part C of the second hole is arranged in the second clamping part, and Part D is arranged in the rear part. In addition, Part C extends toward the opening side. The length of Part C from the rear part to the opening side is given in a closed interval [1/10L, 1/2L], where L is the length of the second clamping part from the rear part to the opening side. When the binder clip is used, the first rod member passes through the first hole and contacts one end of the first clamping part against the opening side of Part A, forming the first fulcrum. From the first fulcrum to the pivotal part, a gap exists between the first rod member and the first clamping part; when the binder clip is used, the second rod member passes through the second hole and contacts one end of the second clamping part against the opening side of Part C, forming the second fulcrum. From the second fulcrum to the pivotal part, a gap exists between the second rod member and the second clamping part.

When the first rod member is pressed, Part B provides space for pressing the first rod member. When the second rod member is pressed, Part D provides space for pressing the second rod member.

Preferably, H is equal to L.

Preferably, the length of Part A is equal to that of Part C.

Preferably, the first hole and the second hole are both continuous holes.

Preferably, the length of Part A is greater than that of Part B, and the length of Part C is greater than that of Part D.

Preferably, the length of Part A is equal to that of Part C, and the length of Part B is equal to that of Part D.

Preferably, the length of Part A is 1/5H, and the length of Part C is 1/5L.

Preferably, the length of Part A is 3/10H, and the length of Part C is 3/10L.

Preferably, the length of Part A is 2/5H, and the length of Part C is 2/5L.

Preferably, the length of the first rod member exceeding the rear part is equal to or greater than that of the remaining part, and the length of the second rod member exceeding the rear part is equal to or greater than that of the remaining part.

### (iii) Technical Effect

The effort-saving binder clip disclosed in the present invention can effectively overcome the deficiencies of the prior art.

From the structure disclosed in the present invention, the first fulcrum is formed by the contact between the first rod member and one end of the first clamping part at the opening side of Part A, and the second fulcrum is formed by the contact between the second rod member and one end of the second clamping part at the opening side of Part C. The length of Part A is determined by the length of the first clamping part from the rear part to the opening side, and that of Part C is determined by the length of the second clamping part from the rear part to the opening side. In addition, the length range of both Part A and Part C is limited. Meanwhile, when the first rod member is pressed, Part B provides space for pressing the first rod member. When the second rod member is pressed, Part D provides space for pressing the second rod member. Therefore, the first hole and the second hole are designed to save effort, which completely gets out of the conventional mindset in the industry. Additional protruding fulcrums are not necessarily arranged on the clamping parts or rod members to achieve the purpose of saving effort. Since the first hole is arranged between the first clamping part and the rear part, and the second hole is arranged between the second clamping part and the rear part, that is, the holes are opened on the upper part, which greatly simplifies production and saves effort with convenience for assembling the rear part.

### DESCRIPTION OF THE DRAWINGS

FIG. 1 is a three-dimensional schematic diagram of the present invention in an initial position.

FIG. 2 is a three-dimensional schematic diagram of the present invention when used.

FIG. 3 is a side view of the present invention.

FIG. 4 is an enlarged schematic diagram of M.

FIG. 5 is a three-dimensional schematic diagram showing the length of the Part A.

### DESCRIPTION OF THE REFERENCE NUMERALS

1. Rear part; 2. Pivotal part; 3. First clamping part; 4. Second clamping part; 5. First rod member; 6. Second rod member; 7. Part A; 8. Part B; 9. Second hole; 10. First fulcrum; 11. Gap; 12. Length H; 13. Length of Part A.

### DETAILED DESCRIPTION OF PREFERRED EMBODIMENTS

For better understanding of the present invention, the present invention will be illustrated in detail below with reference to the accompanying drawings and specific embodiments.

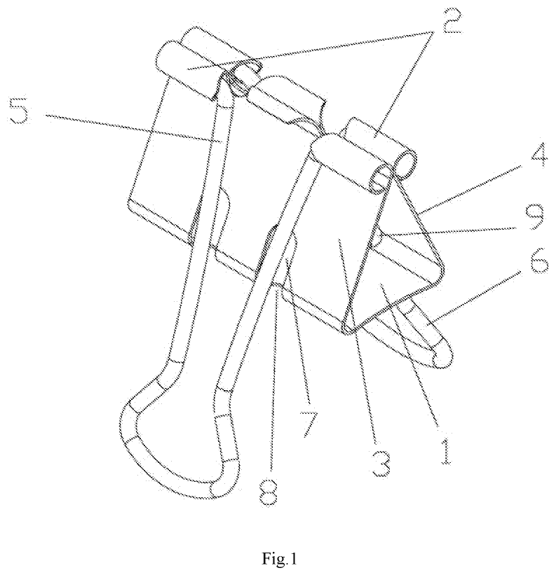

As shown in FIG. 1, the effort-saving binder clip comprises the clamping parts, the rear part 1, and the rod members. Two clamping parts are arranged The rear part 1 is arranged at one end of the clamping part and connects the two clamping parts. In this embodiment, the rear part 1 is connected to the two clamping parts by arc transition. The two clamping parts form an openable opening at the other end. The pivotal part 2 is arranged at the other end of each clamping part. The rear part 1, the two clamping parts, and the two pivotal parts 2 form the clip body. Two rod members are arranged and correspond to the clamping parts. In common practice, the above structure is integrally produced by metal sheet processing, that is, an integrated clip body is formed.

The two clamping parts are marked as the first clamping part 3, the second clamping part 4, and the two rod members are marked as the first rod member 5, and the second rod member 6, respectively. When the binder clip is used, one end of the first rod member 5 and one end of the second rod member 6 both exceed in length the rear part 1 for the convenience of users to press the exceeding parts against each other. The other end of the first rod member 5 is pivotally connected to the pivotal part 2 of the first clamping part 3, and the other end of the second rod member 6 is pivotally connected to the pivotal part 2 of the second clamping part 4.

In this embodiment, the first clamping part 3, the second clamping part 4, the first rod member 5 and the second rod member 6 are basically symmetrically arranged with respect to the rear part 1. The first clamping part 3, the second clamping part 4, the first rod member 5 and the second rod member 6 have basically the same dimensions.

In order to save effort, the structure of the effort-saving binder clip provided by the present invention comprises the following parts:

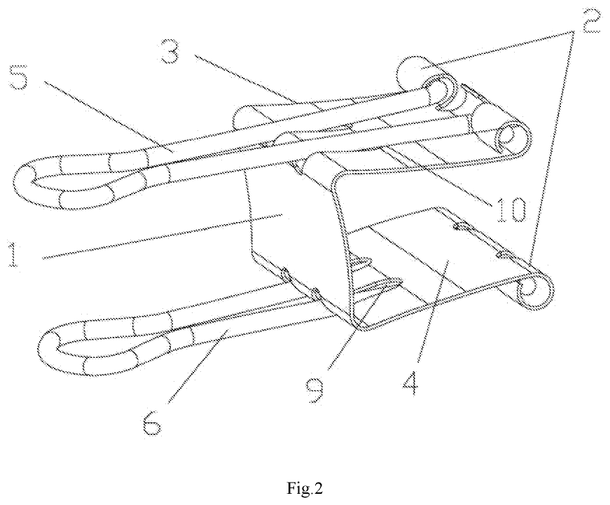

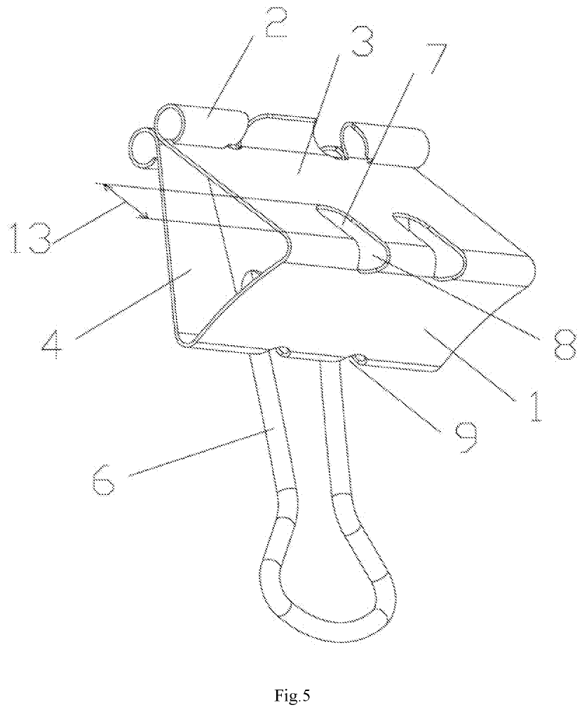

As shown in FIGS. 2 and 5, holes are both arranged between the first clamping part 3 and the rear part 1 and between the second clamping part 4 and the rear part 1. The hole between the first clamping part 3 and the rear part 1 is marked as the first hole, and the hole between the second clamping part 4 and the rear part 1 is marked as the second hole 9. Part A 7 of the first hole is arranged in the first clamping part 3, and Part B 8 is arranged in the rear part 1. In addition, Part A 7 extends toward the opening side. The length of Part A 7 from the rear part 1 to the opening side is given in the closed interval [1/10H, 1/2H], and H is the length of the first clamping part 3 from the rear part 1 to the opening side. For the convenience of identification, the reference numeral of H is 12, and that of the length of Part A 7 is 13 in the accompanying drawings; Part C of the second hole is arranged in the second clamping part 4, and Part D is arranged in the rear part 1. In addition, Part C extends toward the opening side. The length of Part C from the rear part 1 to the opening side is given in the closed interval [1/10L, 1/2L], and L is the length of the second clamping part 4 from the rear part 1 to the opening side. In this embodiment, the second hole 9 and the first hole are symmetrically arranged with respect to the rear part 1. The first hole has the same structure, size and parallel relationship as the second hole 9.

When the binder clip is used, the first rod member 5 passes through the first hole, and the first rod member 5 contacts one end of the first clamping part 3 against the opening side of Part A 7, forming the first fulcrum 10. From the first fulcrum 10 to the pivotal part 2, the gap 11 exists between the first rod member 5 and the first clamping part 3; when the binder clip is used, the second rod member 6 passes through the second hole 9, the second rod member 6 contacts one end of the second clamping part 4 against the opening side of Part C, forming the second fulcrum. From the second fulcrum to the pivotal part 2, the gap 11 exists between the second rod member 6 and the second clamping part 4.

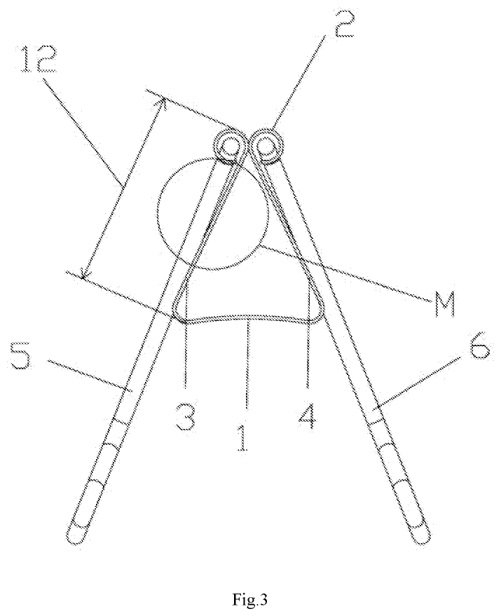

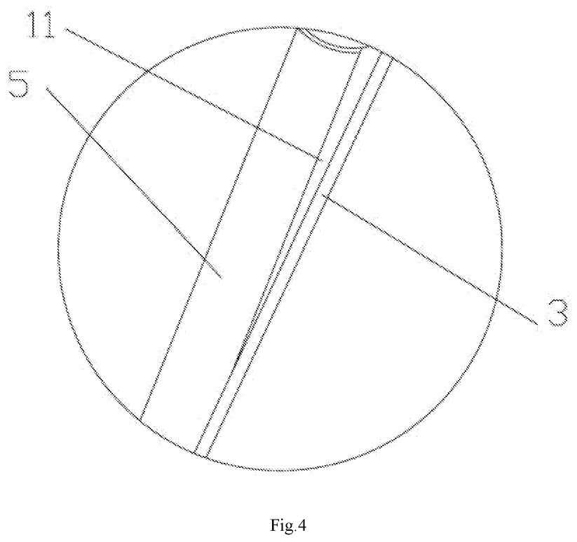

As shown in FIGS. 3 and 4, the gap 11 already exists in the initial position before being pressed to ensure the formation of the first fulcrum 10 and the second fulcrum. As shown in FIG. 2, when pressing, the first fulcrum 10 and the second fulcrum can be formed as designed. In addition, as the opening width increases, due to the deformation of the first clamping part 3 and the second clamping part 4, the area of contact between the first rod member 5 and one end of the first clamping part 3 at the opening side of Part A 7, and that of contact between the second rod member 6 and one end of the second clamping part 4 at the opening side of Part C both become larger toward the opening side, which helps reduce resisting arms to a certain extent, and saves more effort.

When the first rod member 5 is pressed, Part B 8 provides space for pressing the first rod member 5. When the second rod member 6 is pressed, Part D provides space for pressing the second rod member 6.

Due to the symmetrical arrangement with respect to the rear part 1, H is equal to L, the length of Part A 7 is equal to that of Part C, and the length of Part B 8 is equal to that of Part D.

In this embodiment, both the first hole and the second hole 9 are continuous holes. The length of Part A 7 is greater than that of Part B 8, and the length of Part C is greater than that of Part D. The length of Part A 7 is 2/5H, the length of Part C is 2/5L, and H is equal to L.

Other embodiments are also available, in which the length of Part A 7 is 1/5H, and that of Part C is 1/5L; the length of Part A 7 is 3/10H, and that of Part C is 3/10L.

To facilitate the deformation of the clip and ensure the strength of the material, this embodiment provides two first holes and two second holes 9. The two first holes are parallel to each other and the two second holes 9 are also parallel to each other in the direction of the rear part 1 extending to the opening.

To save more effort, the length of the first rod member 5 beyond the rear part 1 is equal to or greater than that of the remaining part, and the length of the second rod member 6 beyond the rear part 1 is equal to or greater than that of the remaining part, that is, the part of the first rod member 5 at the rear side of the rear part 1 is equal to or greater than that of the first rod member 5 at the front side of the rear part 1, and the part of the second rod member 6 at the rear side of the rear part 1 is equal to or greater than that of the first rod member 6 at the front side of the rear part 1. In this embodiment, the length of the first rod member 5 at the rear side of the rear part 1 is greater than that of the first rod member 5 at the front side of the rear part 1, and the length of the second rod member 6 at the rear side of the rear part 1 is greater than that of the second rod member 6 at the front side of the rear part 1.

The above descriptions are only illustrative of the present invention, so any equivalent changes or modifications made in accordance with the structures, features and principles of the present invention described herein are included within the scope of the present invention.

What is claimed is:

1. An effort-saving binder clip, comprising clamping parts, a rear part, and rod members. Two clamping parts are arranged, the rear part is arranged at one end of the clamping parts and connects the two clamping parts which form an openable opening at the other end. A pivotal part is arranged at the other end of each clamping part. Two rod members are arranged and correspond to the clamping parts. The two clamping parts are marked as the first clamping part, the second clamping part, and the two rod members are marked as the first rod member, the second rod member, respectively. When the binder clip is used, one end of the first rod member and one end of the second rod member both exceed in length the rear part for the convenience of users to press the exceeding parts against each other. The other end of the first rod member is pivotally connected with the pivotal part of the first clamping part, and the other end of the second rod member is pivotally connected with the pivotal part of the second clamping part, wherein holes are both arranged between the first clamping part and the rear part and between the second clamping part and the rear part. The hole between the first clamping part and the rear part is marked as a first hole, and the hole between the second clamping part and the rear part is marked as a second hole. Part A of the first hole is arranged in the first clamping part, and Part B is arranged in the rear part. In addition, Part A extends toward the opening side. The length of Part A from the rear part to the opening side is given in a closed interval [1/10H, 1/2H], where H is the length of the first clamping part from the rear part to the opening side; Part C of the second hole is arranged in the second clamping part, and Part D is arranged in the rear part. In addition, Part C extends toward the opening side. The length of Part C from the rear part to the opening side is given in a closed interval [1/10L, 1/2L], where L is the length of the second clamping part from the rear part to the opening side. When the binder clip is used, the first rod member passes through the first hole and contacts one end of the first clamping part against the opening side of the Part A, forming a first fulcrum. From the first fulcrum to the pivotal part, a gap exists between the first rod member and the first clamping part; when the binder clip is used, the second rod member passes through the second hole and contacts one end of the second clamping part at the opening side of Part C, forming a second fulcrum. From the second fulcrum to the pivotal part, a gap exists between the second rod member and the second clamping part.
When the first rod member is pressed, Part B provides space for pressing the first rod member. When the second rod member is pressed, Part D provides space for pressing the second rod member.

2. The effort-saving binder clip according to claim 1, wherein H is equal to L.

3. The effort-saving binder clip according to claim 1 or 2, wherein the length of Part A is equal to that of Part C.

4. The effort-saving binder clip according to claim 1 or 2, wherein the first hole and the second hole are both continuous holes.

5. The effort-saving binder clip according to claim 1 or 2, wherein the length of Part A is greater than that of Part B, and the length of Part C is greater than that of Part D.

6. The effort-saving binder clip according to claim 5, wherein the length of Part A is equal to that of Part C, and the length of Part B is equal to that of Part D.

7. The effort-saving binder clip according to claim 1 or 2, wherein the length of Part A is 1/5H, and the length of Part C is 1/5L.

8. The effort-saving binder clip according to claim 1 or 2, wherein the length of Part A is 3/10H, and the length of Part C is 3/10L.

9. The effort-saving binder clip according to claim 1 or 2, wherein the length of Part A is 2/5H, and the length of Part C is 2/5L.

10. The effort-saving binder clip according to claim 1 or 2, wherein the length of the first rod member exceeding the rear part is equal to or greater than that of the remaining part, and the length of the second rod member exceeding the rear part is equal to or greater than that of the remaining part.
